(19) United States
(12) Patent Application Publication
(10) Pub. No.: US 2025/0252332 A1
(43) Pub. Date: Aug. 7, 2025

(54) System and Method for Separating a Quantum State Into Multiple Subspaces

(71) Applicant: Quantinuum Ltd., London (GB)

(72) Inventors: Adam Peter Connolly, London (GB); Ismail Yunus Akhalwaya, London (GB)

(73) Assignee: Quantinuum Ltd., London (GB)

(21) Appl. No.: 19/043,957

(22) Filed: Feb. 3, 2025

(30) Foreign Application Priority Data
Feb. 1, 2024 (GB) 2401344.3

(51) Int. Cl. G06N 10/20

(52) U.S. Cl. CPC G06N 10/20

(57) ABSTRACT

A quantum computer system and a method for using such a quantum computer system are provided. The quantum computer system comprises a first register and a second register which are used to separate a quantum state into multiple subspaces of a 2n dimensional Hilbert space. The method comprises defining a quantum state comprising 2n elements on the first register, the first register comprising n qubits; defining a quantum state on the second register, the second register comprising one or more qubits; and receiving a value k, where k is a binary integer such that 0=<k=<n. The method further comprises performing a bit-wise iteration process to separate the quantum state on the first register into distinct subspaces of the Hilbert space, wherein elements of the distinct subspaces have different Hamming weights and exactly one of the subspaces contains only elements of Hamming weight k.

### CROSS-REFERENCE TO RELATED APPLICATIONS

This application claims priority under 35 U.S.C. § 119 to GB Application No. 2401344.3, filed Feb. 1, 2024, the entire contents of which are incorporated herein by reference.

### FIELD

The present application relates to a system and method for separating a quantum state into multiple subspaces, for example to obtain a subspace comprising elements having a specified Hamming weight k.

### BACKGROUND

States on n-qubit quantum devices are elements of a 2ⁿ dimensional Hilbert space. In many applications of such devices, it is important to prepare and maintain (provide) states which are restricted to subspaces of this Hilbert space. One such family of subspaces is that of the k-Hamming weight computational basis states (see https://en.wikipedia.org/wiki/Hamming_weight for additional information on Hamming weights). This subspace is particularly important when the states of the n-qubit quantum device are used to represent the behaviour of n discrete physical, logical or geometric objects, for example interacting systems of particles, biomarkers or network nodes. In these cases, the k-Hamming weight subspace can be used to represent the interactions between k out of n of the objects. For most of these applications, the objects themselves are distinguishable only by their interactions with other objects.

For this reason, an important problem in such applications is how to restrict or project an n-qubit state to the k-Hamming weight subspace, both at the beginning of a computation (in state preparation) and throughout the computation (mid-circuit). These projections allow us to filter the quantum states on the device to focus on ones having a certain Hamming weight or set of Hamming weights. One problem addressed here is how to perform this projection via quantum entanglement, for example using an auxiliary register, followed by measurement. Although known solutions are available for this problem, there is a desire to improve such solutions, for example to improve computational efficiency and/or to provide additional functionality when working with k-Hamming weights.

The following papers provide examples of research relating to the technical area described herein (the first two providing an existing solution to the problem of how to perform the above projection).
Ionicioiu, R., Popescu, A. E., Munro, W. J., and Spiller, T. P. Generalized parity measurements. Phys. Rev. A 78 (November 2008), 052326. This paper discloses generalised parity measurements for state preparation
Ubaru, S., Akhalwaya, I. Y., Squillante, M. S., Clarkson, K. L., and Horesh, L. Quantum topological data analysis with linear depth and exponential speedup. arXiv:2108.02811 (2021). This paper discloses mid-circuit projections applied to constructing Laplacians.
Cruz, D., Fournier, R., Gremion, F., Jeannerot, A., Komagata, K., Tosic, T., Thiesbrummel, J., Chan, C. L., Macris, N., Dupertuis, M. -A. and Javerzac-Galy, C. Efficient Quantum Algorithms for GHZ and W States, and Implementation on the IBM Quantum Computer. Adv. Quantum Technol., 2:1900015. https://doi.org/10.1002/qute.201900015 (2019). This paper proposes efficient deterministic algorithms with logarithmic step complexities for the generation of entangled GHZ_{N} and W_{N} states useful for quantum networks.
Ismail Yunus Akhalwaya, Shashanka Ubaru, Kenneth L. Clarkson, Mark S. Squillante, Vishnu Jejjala, Yang-Hui He, Kugendran Naidoo, Vasileios Kalantzis, and Lior Horesh. Towards Quantum Advantage on Noisy Quantum Computers. https://arxiv.org/abs/2209.09371 (2022). This paper relates to noisy intermediate-scale quantum topological data analysis (NISQ-TDA) and presents an implemented end-to-end quantum machine learning method needing only a short circuit-depth.
Bärtschi, A., Eidenbenz, S. (2019). Deterministic Preparation of Dicke States. In: Gąsieniec, L., Jansson, J., Levcopoulos, C. (eds) Fundamentals of Computation Theory. FCT 2019. Lecture Notes in Computer Science, vol 11651. Springer, Cham. https://doi.org/10.1007/978-3-030-25027-0_9. Bärtschi and S. Eidenbenz, “Short-Depth Circuits for Dicke State Preparation,” 2022 IEEE International Conference on Quantum Computing and Engineering (QCE), Broomfield, CO, USA, 2022, pp. 87-96, doi: 10.1109/QCE53715.2022.00027. These two citations above both provide efficient ways of preparing the k-Dicke state on n qubits using a single register. The k-Dicke state is a specific quantum state in the k-Hamming weight space; in particular, the k-Dicke state is the uniform superposition over all computational basis states having Hamming weight k.

### SUMMARY

The invention is defined in the appended claims.

A quantum computer system and a method for using such a quantum computer system are disclosed. The quantum computer system comprises a first register and a second register which are used to separate a quantum state into multiple subspaces of a 2ⁿ dimensional Hilbert space. The method comprises defining a quantum state comprising 2ⁿ elements on the first register, the first register comprising n qubits; defining a quantum state on the second register, the second register comprising one or more qubits; and receiving a value k, where kis a binary integer such that 0=<k=<n. The method further comprises performing a bit-wise iteration process comprising: (i) performing a quantum entanglement between the first and second registers to separate the quantum state on the first register into distinct subspaces of the Hilbert space which are indexed by the entangled values on the second register, and (ii) measuring an outcome on the second register to find a match with a portion of k, wherein said portion of k increases incrementally with the iteration process until the match is with all of k. The bit-wise iteration process is used to separate the quantum state on the first register into distinct subspaces of the Hilbert space, wherein elements of the distinct subspaces have different Hamming weights and exactly one of the subspaces contains only elements of Hamming weight k.

Also disclosed is a method for using a quantum computer system including a quantum circuit comprising a first register and a second register to provide a quantum state representing a subspace of a 2ⁿ dimensional Hilbert space, the quantum state having a k Hamming weight. The method comprises defining a quantum state comprising 2ⁿ elements on the first register of the quantum circuit, the first register comprising n qubits; defining a quantum state on the second register of the quantum circuit, the second register comprising one or more qubits; and receiving a value k, where kis a binary integer such that 0=<k=<n. The method further comprises performing a bit-wise iteration, starting at i=1 corresponding to a least significant bit of k, wherein each iteration comprises: (a) performing a quantum entanglement between the quantum state of the first register and the quantum state of the second register, wherein performing the quantum entanglement includes making a projection of the n qubit state to a subspace U which contains the k Hamming weight subspace; (b) deriving a bit from the quantum entanglement by making a measurement of the second register to realise the projection; (c) determining whether or not the derived bit is equal to the ith bit of k; d) if the derived bit is not equal to the ith bit of k, terminating the method as failing; and (e) if the derived bit is equal to the ith bit of k, incrementing i by one and performing the next iteration, wherein the subspace U converges to the k Hamming weight over the course of the iterations. The method further comprises terminating the bit-wise iteration as a success if the derived bit for i=[log (n+1)] is equal to the most significant bit of k, indicative of the system determining a quantum state having a Hamming weight of k. Also provided is a quantum computing system configured to perform the above method.

Features of the above methods and systems can be combined in any suitable manner according to the circumstances of a given implementation.

In the current NISQ era before universal error correction, computer-implemented methods which are well adapted to the capabilities and requirements of the quantum computing hardware are critically important to extract the greatest efficiency from the available quantum computing hardware. Example computer-implemented methods described herein have the advantage of being adapted to take account of the specific constraints and capabilities of particular quantum computing architectures. In a particular example, the auxiliary register has been configured such that it may be adapted to the routing constraints of the architecture. The controlled phase gates used in the method, coupling the auxiliary register to qubits in the main register, may be performed on any qubit in the auxiliary register. This has significant implications for the problem of routing gates onto physical qubits, both in terms of reducing number of gates and reducing the depth of the circuit.

An example of a computer system architecture for which the configurability of the auxiliary register can be exploited is an ion-trap based quantum computer such as, for example, Quantinuum's H1 and H2 ion-trap based quantum computers. The architectures of these systems provide high connectivity between qubits within an ion trap—the connectivity is not limited to connections between nearest neighbours, and can be up to all-to-all connectivity. In practice, all-to-all connectivity is not essential and the advantages of potentially high connectivity are limited by the transport time to shuttle qubits into gate zones (a region of the quantum computer in which gates may be performed on qubits). Therefore, for an optimal implementation, the auxiliary qubits may be kept physically close to gate zones. This reduces the length of the transport time, enabling a shorter run-time and improving the efficiency of processing. Furthermore, the size of the auxiliary register can be optimized for the number of gate zones available. This would allow for the maximum possible parallelisation for the fewest necessary resources in the auxiliary register.

### BRIEF DESCRIPTION OF THE FIGURES

Various examples and implementations of the disclosure will now be described in detail by way of example only with reference to the following figures:

FIG. 1 provides an example of a quantum circuit diagram giving an overview of the components for Pₖ^{m-1,m}, a single-bit Hamming weight projection.

FIG. 2A provides an example of a quantum circuit diagram for performing a single bit projection Pₖ^{m-1,m}, where

$$θ = \frac{π}{{2}^{m}}$$

for a single auxiliary qubit.

FIG. 2B provides another example of a quantum circuit diagram for performing a single bit projection Pₖ^{m-1,m}, where

$$θ = \frac{π}{{2}^{m}} .$$

FIG. 2b represents a parallel version where all the rotations may be done in depth 2 using an auxiliary register having n/2 qubits. FIG. 2B therefore shows how the circuit may be modified to reduce circuit depth when a larger number of auxiliary qubits are available.

FIG. 3 provides an example of a quantum circuit diagram for Pₖ, the full Hamming weight k projection. In particular, FIG. 3 shows an overview of how to construct the quantum circuit from components which perform single bit projections.

FIG. 4 provides an example of a quantum circuit diagram showing an overview of the components for constructing a single bit controlled Hamming weight projection. If b₁, . . . , bₗ₋₁ are the first l−1 bits of the Hamming weight of q₁, q₂, . . . , qₙ, then the measurement will return the l^{th} bit of the Hamming weight.

FIG. 5 provides an example of a quantum circuit diagram showing an adapted version of the quantum circuit of FIG. 4 which, under certain assumptions, returns 0 from a final measurement if and only if the m^{th} bit of the Hamming weight is kₘ.

FIG. 6 provides an example of a quantum circuit diagram for projecting onto the subspace of states |q₁ . . . qₘ [symbol] for which the m^{th} bit of the Hamming weight (Σqᵢ) agrees with the m^{th} bit of k.

FIG. 7 provides an example of a quantum circuit diagram for projecting onto the subspace of states for which the l^{th} through mth bits of the Hamming weight agree with those of k. The quantum circuit projects onto the space spanned by states |q₁ . . . qₘ [symbol] where all bits between the l^{th} bit and the m^{th} bit of Σqᵢ are the same as those of k.

FIGS. 8A and 8B depict a flowchart which provides an example of a method for obtaining a quantum state having a specified Hamming weight as disclosed herein. The operations shown in FIG. 8B repesent details (sub-operations) of one of the operations shown in FIG. 8A.

FIGS. 9A-9D are examples of variations on the approach shown in FIGS. 8A and 8B. In particular, FIG. 9A illustrates a variation in which a match is achieved for a subset of the bits of the Hamming weight (rather than for the full Hamming weight). FIGS. 9B-9D illustrate variations in which Hamming weight bits are not measured in every iteration but may be used instead to control a separate operation.

FIG. 10 is a schematic diagram showing an example of a quantum computing system for implementing a method for separating a quantum state into multiple subspaces such as disclosed herein, for example to obtain a subspace comprising elements having a specified Hamming weight k.

### DETAILED DESCRIPTION

### 1. Technical Specification of the Quantum Circuits

As disclosed herein, a quantum computer is used to perform projections from a full Hilbert Space on n qubits, [symbol] ₙ (and various different subspaces of this), to the space spanned by computational basis states having Hamming weight k, [symbol] ₖ (and various states made by combining such states). A modular measurement-based procedure is adopted which performs the projections by breaking up the full projection Pₖ: [symbol] ₙ→ [symbol] ₖ into a series of smaller projections.

To this end, the following definitions are adopted:
For any whole number m such that 0<m≤┌logn┐, [symbol] ₖ^{m} represents the subspace of [symbol] ₙ spanned by computational basis states whose Hamming weight, k′ is congruent to k modulo 2^{m}, i.e. the first m bits of k′ match those of k. That is

$${𝒲}_{k}^{m} = {⊕}_{{k}^{′} ≡ k ( mod {2}^{m} )} {W}_{{k}^{′}} .$$

(the ⊕ symbol is the symbol for direct product, which is like the union operator for vector spaces).
For m=0, we adopt the convention that [symbol] ₖ⁰= [symbol] ₙ.
For any whole number m such that 0<m≤┌logn┐, write [symbol] _{<k}^{m} for the direct sum of spaces W_{k′}^{m} for k′=0, 1, . . . , k−1. That is

$${𝒲}_{< k}^{m} = {⊕}_{{k}^{′} = 1}^{k - 1} {W}_{{k}^{′}}^{m} .$$

This defines the space spanned by all states for which the first m bits of their Hamming weight agree with one of 0, 1, 2, . . . , k−1.
For any whole number m such that 0≤m′<m≤┌logn┐, write Pₖ^{m′,m} for the projection from the space [symbol] ₖ^{m′} to the space [symbol] ₖ^{m}. That is,

$${P}_{k}^{{m}^{′} , m} : {𝒲}_{k}^{{m}^{′}} \to {𝒲}_{k}^{m} \vert {x}_{1} … {x}_{n} 〉 \to \{ \begin{matrix}\vert {x}_{1} … {x}_{n} 〉 if \sum {x}_{i} ≡ k ( mod {2}^{m} ) \\ 0 otherwise\end{matrix} .$$

When m′=0, write this projection as Pₖ^{m} for the projection from the space [symbol] ₖ^{m′} to the space [symbol] ₖ^{m}, and for any whole number m when m≥┌logn┐ we have Pₖ=Pₖ^{m}.
For any k≤n, we write P_{<k} for the projection from the full n-qubit Hilbert space [symbol] ₙ to the subspace W_{<k}ⁿ.

We now consider how to construct the quantum circuits for implementing the projections on an n-qubit register using a variable number of qubits from an auxiliary register. We first describe in detail the projection Pₖ¹ which projects from the full n-qubit Hilbert space to the space spanned by computational basis states whose Hamming weight has the same first bit as k and show how to adapt this projection to perform the relative projections Pₖ^{m-1,m}. We then describe how to assemble the relative projections to form Pₖ. Here, the ‘relative projections’ correspond to the projections Pₖ^{(m-1,m)} which handle a single bit. They are ‘relative’ in the sense that they perform a certain projection relative to the assumption on the input that the Hamming weights agree with k for the first m−1 bits. Finally, we describe how to add controlled operations to perform the projections P_{<k}.

### 2. Single Bit Projection

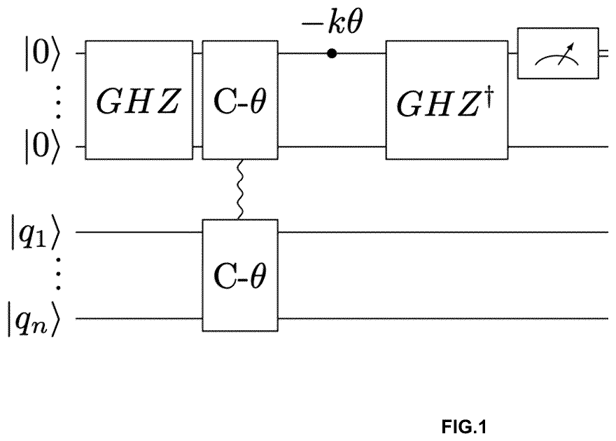

A method is described for performing a single bit projection Pₖ¹ and this can then act as a model for the other, more complicated, projections. The steps of the method or procedure may be implemented as follows on a main (first) register in combination with an auxiliary (second) register, for example, based on the quantum circuit diagram of FIG. 1, which provides an overview of the components for Pₖ^{m-1,m}, a single-bit Hamming weight projection.
1. Prepare a Greenberger-Horne-Zeilinger (GHZ) state on the auxiliary register. That is a state

$$\vert G H {Z}_{a} 〉 = \frac{1}{\sqrt{2}} ( \vert 0 … 0 〉 + \vert 1 … 1 〉 ) .$$

This construction is known (see Cruz et al as cited above) and may be performed in log depth by applying a Hadamard followed by a “fan-out” circuit (see Akhalwaya et al as cited above).
2. For each qubit in the main register, a controlled z-rotation gate is applied to the auxiliary register controlled by that qubit. The angle for this rotation may be

$$θ = \frac{π}{2}$$

and the rotation may be applied to any qubit of the auxiliary register. To minimise gate depth, we cycle through the auxiliary qubits in turn as these controlled rotations are applied.
3. Next, a z-rotation of −kθ is applied to any of the auxiliary qubits.
4. The inverse of the GHZ state preparation circuit is then applied to the auxiliary register.
5. Lastly, the first qubit in the computational basis is measured, and the projection succeeds if the outcome of the measurement is |0 [symbol] .

To extend the above approach to the projection Pₖ^{m-1,m} we do exactly the same process with

$$θ = \frac{π}{{2}^{m}} .$$

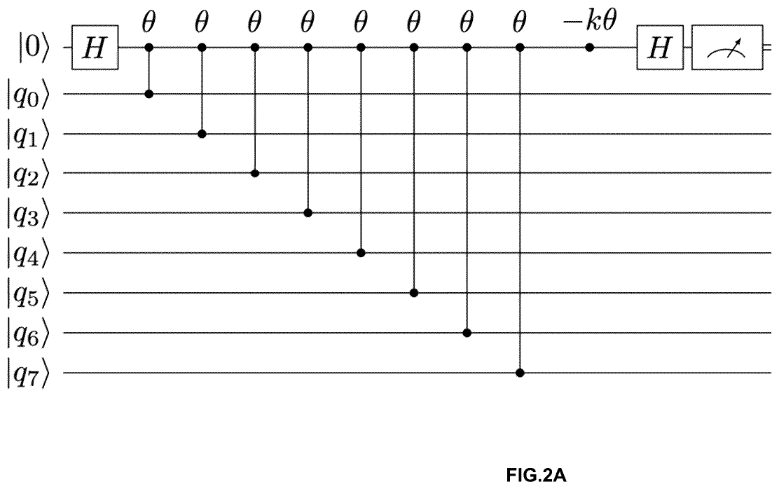

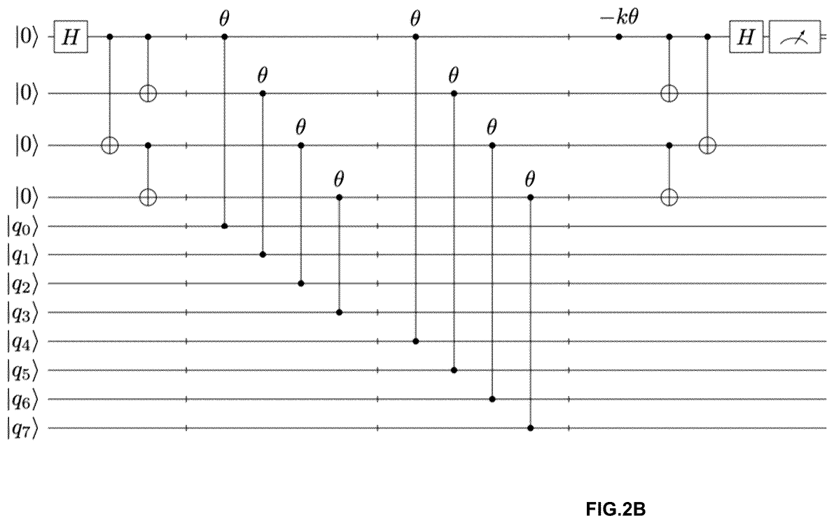

In particular, FIG. 2A shows a quantum circuit for performing a single bit projection Pₖ^{m-1,m}, where

$$θ = \frac{π}{{2}^{m}}$$

for a signle auciliary qubit (the top line in FIG. 2A). FIG. 2B shows an example of a parallel version where all the rotations are performed in depth 2 using n/2 auxiliary qubits (=4 auxiliary qubits in the particular configuration of FIG. 2B). Accordingly, FIGS. 2A and 2B illustrate how the quantum circuit may be modified to utilise a reduced circuit depth when additional auxiliary qubits are available—such a lower circuit depth allows a smaller quantum circuit to be used which is then more resistant to noise.

### 3. Bit-Wise Hamming Weight Projection

The above relatively simple projections can be assembled to perform (obtain) the full projection Pₖ. Mathematically, the projection can be written as a product of successive projections,

$${P}_{k} = {P}_{k}^{m - 1 , m} … {P}_{k}^{1 , 2} \cdot {P}_{k}^{0 , 1} ,$$

where m=┌logn┐. The projection Pₖ may therefore be performed by successively applying the single bit projections Pₖ^{m-1,m} for m=1, . . . , ┌logn┐. This overall (full) projection succeeds if and only if each of the constituent projections succeeds. This gives the advantage of being able to detect failure of the projection at multiple points in the running of the circuit, thereby leading to a shorter circuit on average.

### 4. Controlled Operations and Projecting on Arbitrary Bits

The quantum circuits in the previous two sections perform Hamming weight projections one bit at a time, starting from the lowest bit. In particular, when performing the projection Pₖ^{m,m+1} with a quantum circuit such as described in FIGS. 2A and 2B, the output of a successful projection is in the space spanned by all computational basis states whose Hamming weights agree with k on the m+1^{th} bit. To achieve this, the input state must be in the space spanned by all computational basis states whose Hamming weights agree with k on every bit up to the mth bit.

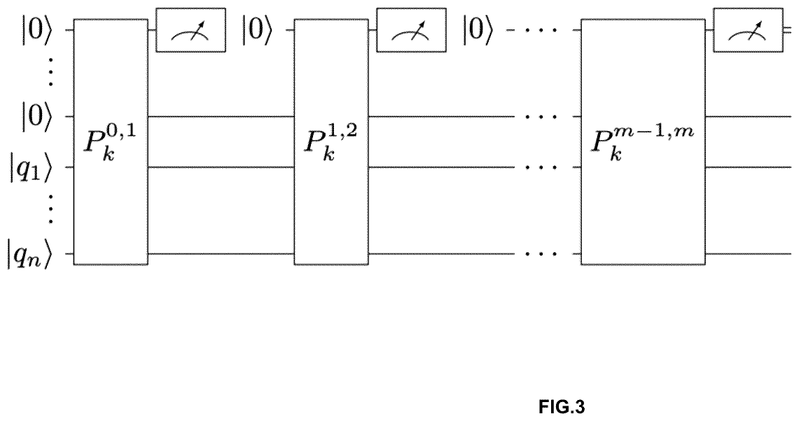

FIG. 3 provides an example quantum circuit diagram for Pₖ, the full Hamming weight k projection. This diagram provides an overview of how to construct the quantum circuit from components which perform single bit projections.

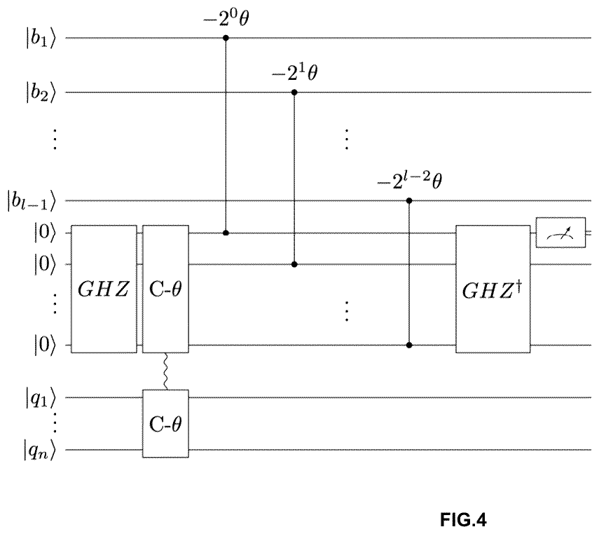

There are important applications however where we only care about projecting onto the space spanned by states whose Hamming weight agrees with k on the lth bit alone (without any assumption on the other bits). To this end, we refer to FIG. 4 which provides an example of a quantum circuit diagram showing an overview of the components for constructing a single bit controlled Hamming weight projection. If b₁, . . . , bₗ₋₁ are the first l−1 bits of the Hamming weight of q₁, q₂, . . . , qₙ then the measurement will return the l^{th} bit of the Hamming weight. Thus in FIG. 3, the output is a collection of substates which have (share) a predetermined Hamming weight, whereas in FIG. 4, the output is the value of a particular bit in the Hamming weight.

Without measurement, this circuit based on FIG. 4 is called CP^{l}. If a measurement is performed, this forces the circuit to collapse into one of the two cases which the circuit has separated corresponding to the two possible values of the l^{th} bit of the Hamming weight; removing the measurement allows us to keep both cases in superposition along with the extra qubit of information which can be used in later computations. The quantum circuit from FIG. 4 performs the projection in the main (data or “q”) register onto the space spanned by computational basis states whose Hamming weights agree with the lth bit of k (as long as the input state is in the space spanned by states |b₁ . . . bₗ₋₁ [symbol] |0 [symbol] |q₁ . . . qₙ [symbol] where b₁, . . . , bₗ₋₁ are the first l−1 bits of the Hamming weight Σqᵢ).

Note that the controlled phase operations between the “b” register and the auxiliary register may be placed on any qubit of the auxiliary register (the b register, which is also referred to herein as the control register) may be implemented separately from or in combination with the main and/or auxiliary registers). In particular, in some implementations, there may not be l−1 qubits available in the auxiliary register. However, if there are enough qubits available from the auxiliary register, then the phase gates may be spread out to save depth (and so improve noise resistance).

If we remove the measurement from this circuit of FIG. 4, it can be seen that after applying this circuit

$$( with θ = \frac{π}{{2}^{l}} )$$

to a state |b [symbol] 0 [symbol] |q [symbol] as described above, the first qubit of the auxiliary register will store the lth bit of the Hamming weight of q and the other qubits of the auxiliary register will be in the state |0 [symbol] . We refer to this circuit as CP^{l}, where C denotes the control from the b register. Note that CP¹ has no control register and prepares the first bit of the Hamming weight of the main register—we will call this P¹ to indicate the lack of a control register.

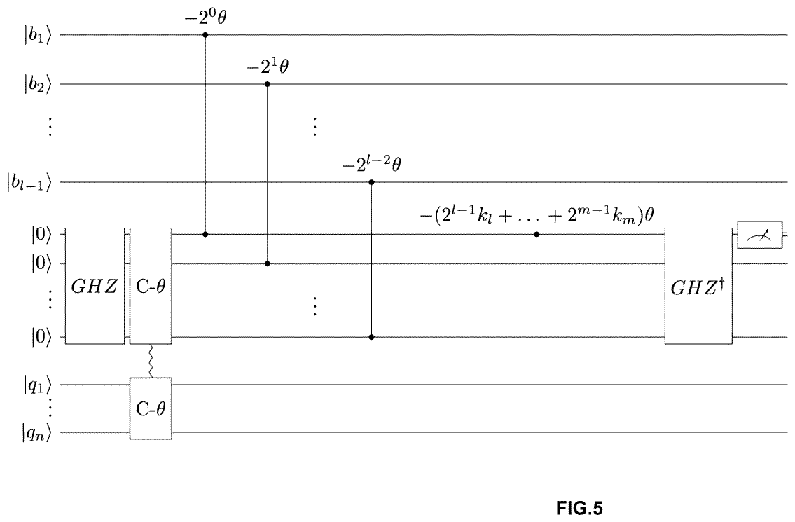

FIG. 5 provides a quantum circuit diagram showing an adapted version of the CP^{l} circuit which, under certain assumptions, returns 0 from the final measurement if and only if the m^{th} bit of the Hamming weight is kₘ. This circuit is called CPₖ^{l,m}. Adapting this construction, the quantum circuit CPₖ^{l,m} is formed by setting

$$θ = \frac{π}{{2}^{m}}$$

and adding a single Z gate of angle −(2^{l-1}kₗ+ . . . +2^{m-1}kₘ)θ before the GHZ^{†} block, where kᵢ is the ith bit of k. When applied to a computational basis state |b [symbol] |0 [symbol] |q [symbol] where b₁, . . . , bₗ₋₁, kₗ, . . . kₘ₋₁ are the first m−1 bits of the Hamming weight Σqᵢ, the measurement at the end will yield 0 if and only if the mth bit of the Hamming weight is kₘ, the mth bit of k. A simple adaptation to this circuit (removing the kₘ component of the final Z rotation) results in a measurement which returns the mth bit of the Hamming Weight Σqᵢ. This variant is used in later examples. We write CPₖ^{l} for the circuit CPₖ^{l,l}.

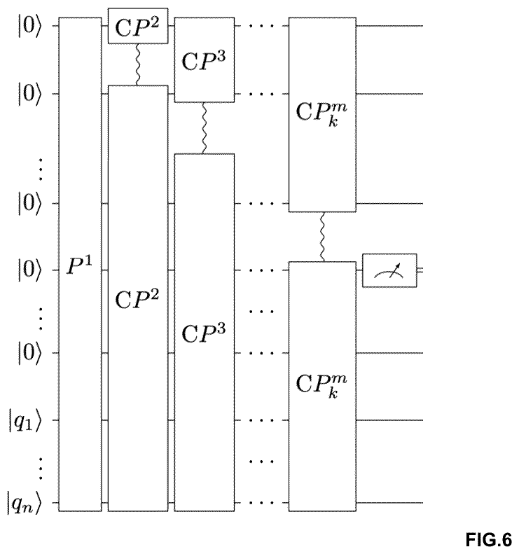

FIG. 6 provides a quantum circuit diagram for projecting onto the subspace of states for which the m^{th} bit of the Hamming weight is the same as that of k. In other words, we can use this modified circuit to construct a projection onto the space spanned by computational basis states whose Hamming weights agree with k on the mth bit. The circuit projects onto the space spanned by states |q₁ . . . qₙ [symbol] , assuming that the mth bit of Σqᵢ is the same as that of k. The first m−1 subcircuits prepare a register containing the first m−1 bits of the Hamming weight and the final subcircuit and measurement use these to perform the appropriate projection.

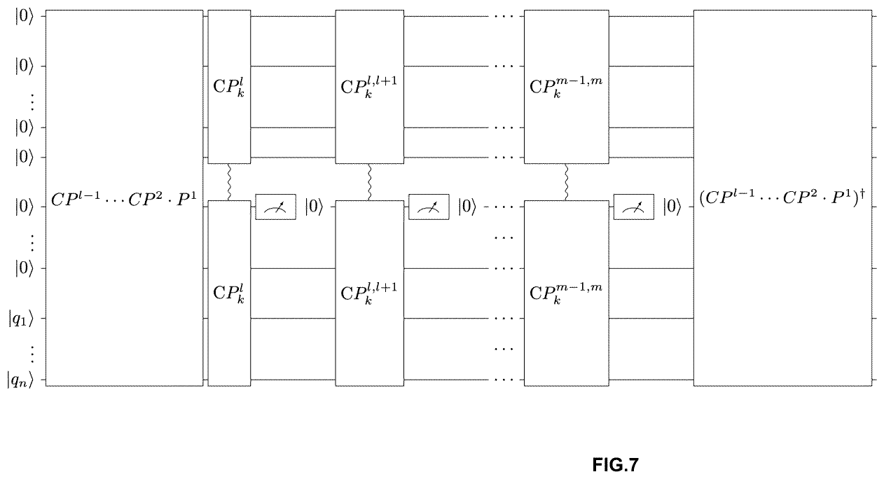

An extension to the configuration in FIG. 6 is shown in FIG. 7. Here we combine the bitwise construction in FIG. 3 and the conditional construction in FIG. 6. This allows us to perform a projection onto Hamming weights where multiple bits (but not all bits) agree with the bits of k. In particular, FIG. 7 provides a quantum circuit diagram for projecting onto the subspace of states for which the l^{th} through mth bits of the Hamming weight agree with those of k. The circuit projects onto the space spanned by states |q₁ . . . qₙ [symbol] where all bits between the lth and the mth bit of Σqᵢ are the same as those of k. For example, if we set k=0 and m=┌log₂ (n+1)┐, this construction performs the projection onto the space spanned by states with Hamming weight strictly less than 2^{{l-1}}. The block at the end ensures that the auxiliary qubits storing the bits of the first l−1 bits of the Hamming weight are “uncomputed” to zero. In particular, at the end of the computation, we want to return the auxiliary register to all 0's. Doing this without affecting the state on the data register is called “uncomputing” the auxiliary qubits. This is a standard term in quantum computing and is usually performed (as here) by applying the inverse of the series of entangling operations which computed the auxiliary qubits in the first place.

It will be appreciated that the present approach may use some known components (e.g. GHZ preparation circuits) but these may be included in a particular method or system to provide bitwise Hamming weight checks as described herein. Accordingly, the present approach supports the determination of Hamming weights in a quantum computing environment and helps to improve/supplement existing implementations. For example, the approach described herein may be performed with smaller and shallower quantum circuits (compared with existing solutions), which is important for near-term applications of quantum computing.

The approach described herein generally involves (inter alia) three parts. The first part is the use of a reduced (short)-depth circuit in conjunction with a variable number of auxilliary qubits for performing a single bit projection. This part is implemented with a quantum circuit that performs a projection from the whole Hilbert space on n-qubits to the space spanned by those states whose Hamming weights are either even or odd.

In particular, each “computational basis state” has a Hamming weight which is either even or odd. In general, a state may be a superposition of basis states with even or odd Hamming weight. The projections are used to separate this superposition according to information about the Hamming weight of each constituent state.

As depicted in FIGS. 2A and 2B, this bit check may be performed with a short depth using controlled phase gates and GHZ preparation circuits. The depth of this circuit is logarithmic in m, the number of qubits in the second (auxiliary) register, with an additional depth contribution of n/m from the controlled phase gates, thereby giving an overall depth of logn when m is linear in n.

The second part of the present approach is a scheme for organising the circuits in FIGS. 2A and 2B, which perform one bit of the bitwise projections, to determine the full Hamming weight k projection from the full Hilbert space to the space spanned by states of Hamming weight k. As depicted in FIG. 3, this is performed in a bitwise manner using logn copies of the single bit projection. The overall depth of this circuit is thus log²n and its modular structure allows for a very efficient use of classical data from the measurements. In particular, a measurement of 1 at any step indicates failure of the projection and thus the circuit can be stopped at this point and repeated if necessary.

There are two common different ways to use a projection P in a quantum computing method. The first is to prepare a desired quantum state P|q> which then gets used in a later quantum computation. Here, repeating until we succeed is involved. The second is when we would like to know what fraction of the input state |q> satisfies the conditions for the projections to succeed. Mathematically this means computing the inner product <q|P|q>. This can be estimated by running the circuit for the projection with input |q> and counting the successes and failures. In this case, the failures are “useful” and we stop when we have enough samples rather than when we achieve a certain outcome (so repetition is not always necessary).

In the third part of the present approach, the single bit projection quantum circuit is controlled to perform further projections based on the Hamming weight of an n-qubit state. FIGS. 6 and 7 show how to perform this adaptation by using the single bit projection modules (without measurements) to prepare additional auxiliary qubits which store some bits of the Hamming Weight.

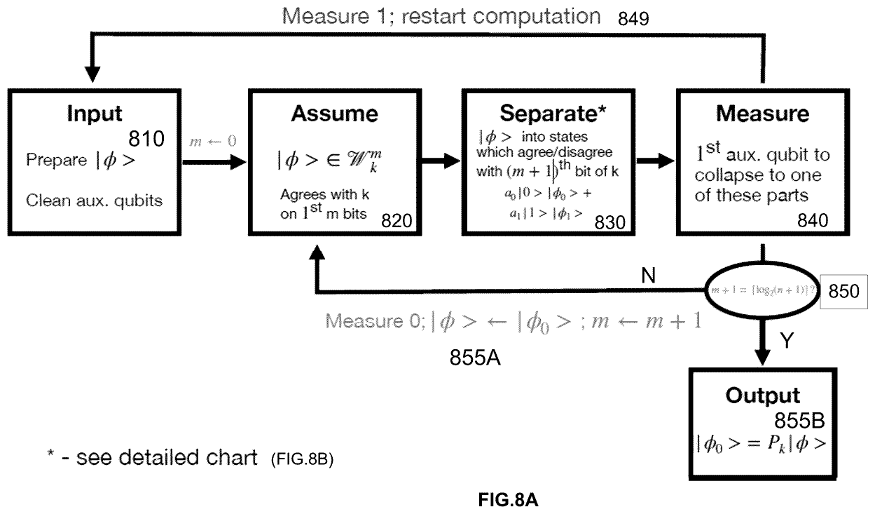

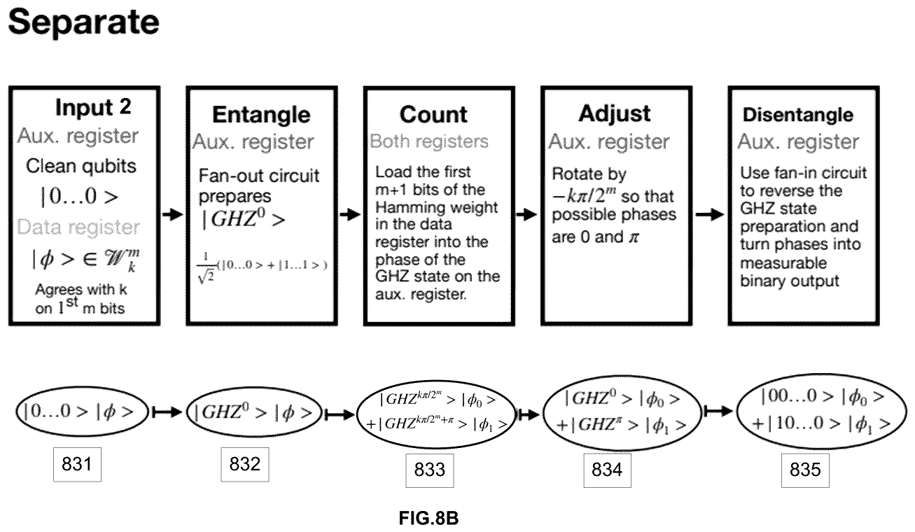

FIGS. 8A and 8B are flowcharts of a method for providing an example of a quantum state having a specified Hamming weight as disclosed herein—see in particular the above sections: 1. Technical specification of the quantum circuits; 2. Single bit projection; and 3. Bit-wise Hamming weight projection. The operations shown in FIG. 8B repesent details (sub-operations) of one of the operations shown in FIG. 8A.

In the Input operation 810, the main (first/data) register is prepared into an initial state |φ> that supports various operations being performed on the qubits. In addition, the qubits of the auxiliary (second) register are cleaned (set to zero). The initial value of mis set to 0.

Operations 820, 830, 840, 850, 855A and 855B then provide an iteration loop. At the start of the loop, in the Assume operation 820, the state |φ> is assumed to be an element of [symbol] ₖ^{m} which represents the subspace of [symbol] ₙ spanned by computational basis states whose Hamming weight, k′, is assumed to be congruent to k modulo 2^{m}, i.e. the first m bits of k′ are assumed to match those of k. The rationale for this assumption is apparent from sections 2. Single bit projection and 3. Bit-wise Hamming weight projection as set out above.

In the Separate operation 830, the state |φ> is separated into a first set of states which do agree with the (m+1)th bit of k and a second set of states which do not agree with the (m+1)th bit of k. More detail about this separation is provided by FIG. 8B as described further below. A measurement is now performed in operation 840 on the first qubit of the auxiliary register; this has the effect of collapsing the system to the first or second set of states. If the measurement selects the set of states which correspond to the (m+1)th bit of k, then the method proceeds to operation 850. However, if the measurement selects the set of states which do not correspond to the (m+1)th bit of k, this represents a failure to find elements of Hamming weight k. In this case the processing continues to operation 849 which indicates a restart of the computation is required to progress.

Although such a restart increases the time taken to find elements of Hamming weight k, the bitwise nature of the iteration in FIG. 8A allows failed (partial) rejections to be detected relatively quickly. The overall result is the approach of FIG. 8A may be more efficient than architectures in which the full set of computations are performed before a failure is detected.

A test is made at operation 850 to compare m+1 with [log₂ (n+1)], the latter representing the number of bits in n. For the initial iterations, m<[log₂ n], so the output from operation 850 is progressed to operation 855A. In operation 855A, m is incremented and the set of states is now limited to the first or second state from operation 830 according to the measurement 840. It will be appreciated that incrementing m for each iteration allows matching with a greater (increasing) portion of k for each iteration, i.e. matching to a larger number of bits within k.

Given this incrementing of m (and assuming a computation restart of operation 849 is avoided), the comparison of operation 850 will eventually produce a match, i.e. m=[log₂ (n+1)], whereby the analysis for the full bit-length of k is completed. Accordingly, an output is provided at Output operation 855B corresponding to the full projection Pₖ: [symbol] ₙ→ [symbol] ₖ broken down into a series of smaller projections, where [symbol] ₖ represents the subspace of [symbol] ₙ spanned by computational basis states having a Hamming weight of k.

The operations shown in FIG. 8B repesent details (five sub-operations) of the Separate step 850 as shown in FIG. 8A. The (sub) operations are shown in the sequence of boxes in the top half of the diagram, and the elliptic shapes below the boxes represent the stored state information on the main and auxiliary registers after the corresponding (sub) operations have been performed. (The reference numerals beneath the elliptical shapes apply to both the boxes above and the elliptical shapes below).

The first operation is Input 2, which follows on from the Assume box 820 in FIG. 8A. The Input 2 operation 831 may be considered as corresponding to a combination of the Input operation 810 and the Assume box 820 shown in FIG. 8A. The Input 2 operation operation 831 is applied during the iterations of FIG. 8A (whereas Input 810 is only involved in setting up the iterations). In the Input 2 operation, the state |φ> on the main (data) register is an element of [symbol] ₖ^{m} which represents the subspace of [symbol] ₙ spanned by computational basis states whose Hamming weight, k′, is assumed to be congruent to k modulo 2^{m}, i.e. the first m bits of k′ are assumed to match those of k.

The next operation 832 in FIG. 8B is Entangle and produces a quantum entanglement between the auxiliary and main registers. Producing this quantum entanglement involves the preparation of a Greenberger-Horne-Zeilinger (GHZ) state on the auxiliary register. Such a GHZ state may be obtained in log depth by applying a Hadamard followed by a “fan-out” circuit.

Operation 833, Count, is performed in relation to both the main and auxiliary registers. This operation involves loading the first m+1 bits of the Hamming weight in the data (main) register into the phase of the GHZ state on the auxiliary register, see also the elliptical shape contents 833. In operation Adjust 834, the states in the auxiliary register are rotated by −lπ/2^{m}; the motivation of this rotation is to arrange the qubits in the auxiliary register to have possible phases of 0 and π, which supports ready access to the state information held in the auxiliary register. In the final operation of FIG. 8B, Disentangle 835, a fan-in circuit, is used to reverse the GHZ state preparation to turn the phases into measurable binary output.

As indicated above, the operations of FIG. 8B correspond to the Separate operation 830 of FIG. 8A. Accordingly, following the (sub) operation of Distentangle 835, we return from FIG. 8B to the Measure operation 840 of FIG. 8A, which performs a measurement to collapse the first auxiliary qubit as discussed above.

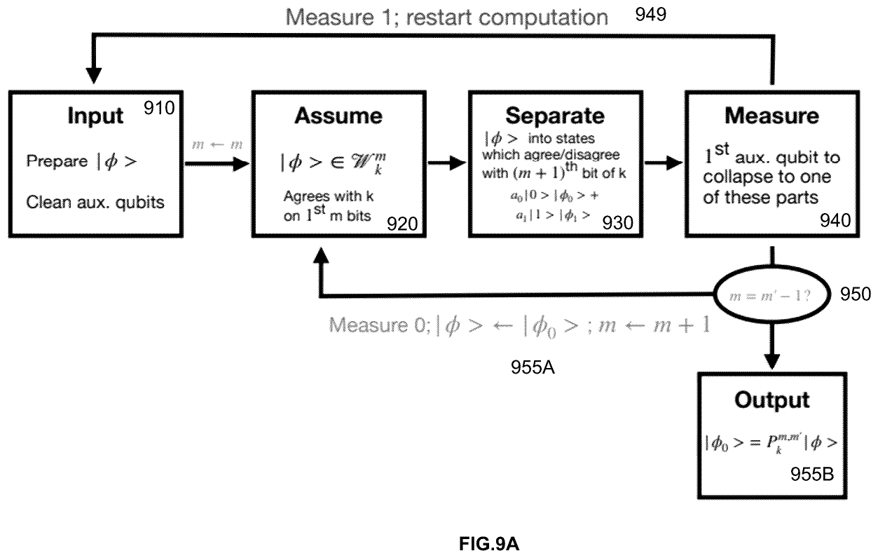

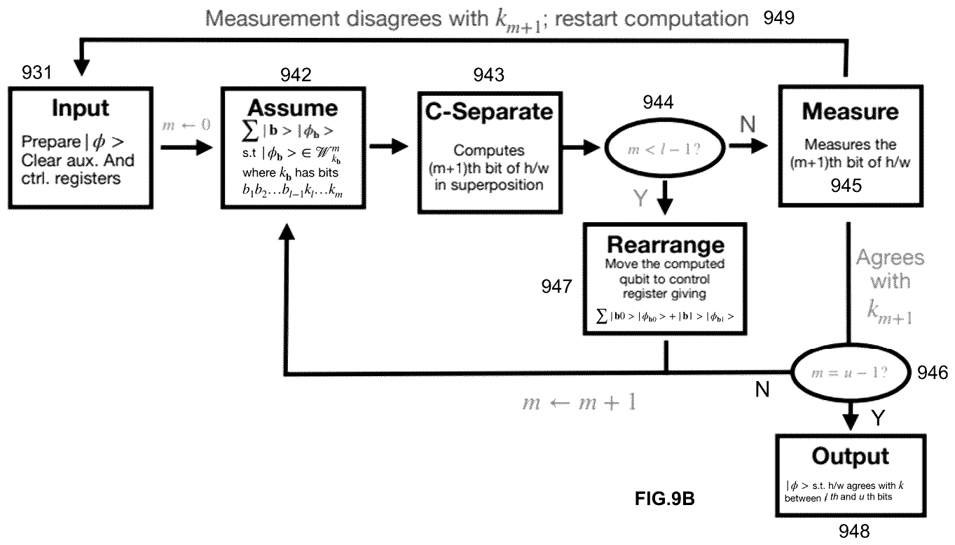

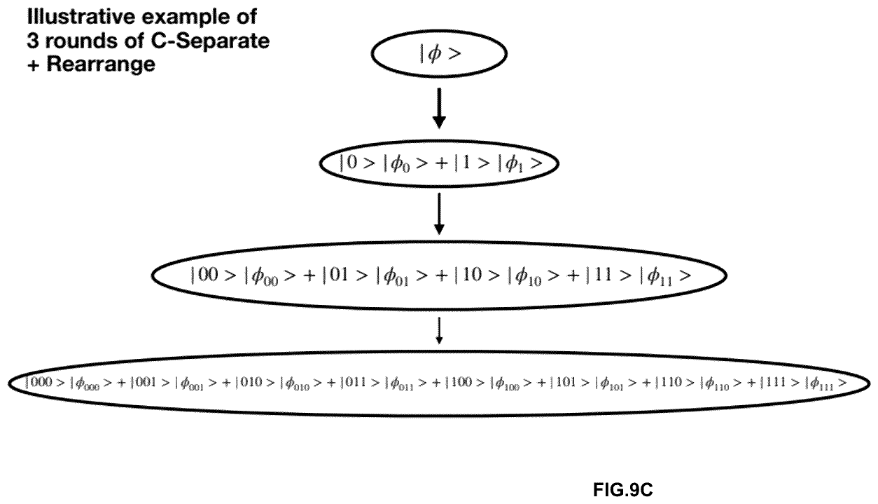

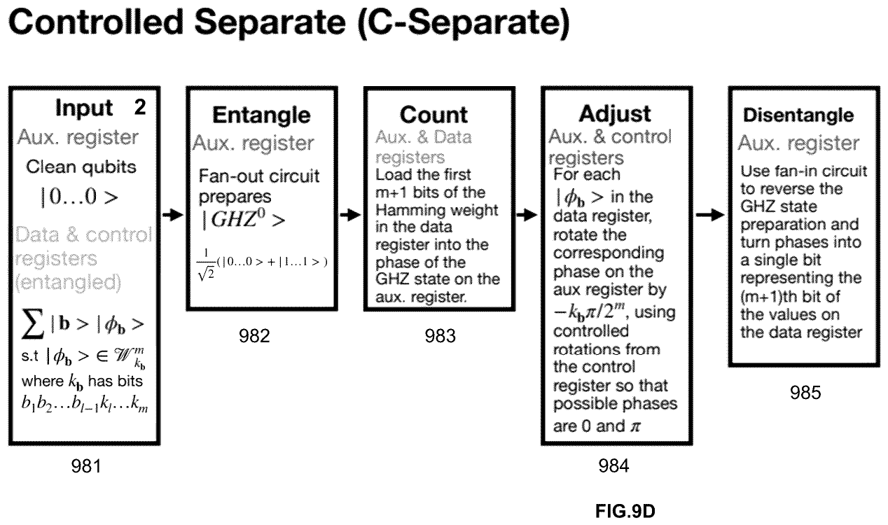

FIGS. 9A-9D are examples of different variations on the approach shown in FIGS. 8A and 8B. In particular, FIG. 9A illustrates a variation in which a match is achieved for a subset of the bits of the Hamming weight (rather than for the full Hamming weight). FIGS. 9B-9D illustrate variations in which Hamming weight bits are not measured in every iteration but may be used instead for controlling a separate operation.

FIG. 9A is a flowchart providing a subset of the k bits of the full Hamming weight; for example, the subset (portion) may comprise bits in the range m->m′. It will be appreciated that many aspects of the processing shown in FIG. 9A match processing in FIG. 8A as indicated by corresponding reference numerals (810, 910; 820, 920, etc). For conciseness, the discussion of FIG. 9A will therefore focus on those aspects of the processing that is different compared with FIG. 8A.

The Input section in Input 810 sets the value of m to 0 corresponding to the initial (least significant) bit of k. With this start, the process of FIG. 8A results in a determination of all the bits of k. In contrast, in FIG. 9A, Input operation 910 sets the value of m to represent the start of the bit range of interest to the user (with respect to the full length of Hamming weight k).

Processing in FIG. 9A then proceeds via the Assume 920 box, the Separate box 930, and the Measure box 940—these operations generally correspond to the operations with the same name in FIG. 8A and so will not be discussed further. (The same applies with respect to the additional processing of FIG. 8B, given that this additional processing represents part of the Separate box as discussed above).

The processing of FIG. 9A at operation 950 then diverges again from that of FIG. 8A at operation 850. In particular, in FIG. 8A the testing determines whether the last bit of the k-Hamming weight has been reached. In contrast, in FIG. 9A the testing 950 determines whether the highest bit of interest (m′) has been reached (rather than the last bit of k).

If the last bit to be tested (according to the appropriate test of 850 or 950) has not been reached, the processing increments m at operation 855A, 955A fand progresses to the next iteration. Operation 955A is generally the same as operation 855A, hence the description above with respect to operation 855A can also be generally applied to operation 955A.

However, if the test 850/950 indicates that the last bit to be tested has been reached, the processing exits via the Output box of 855B, 955B respectively. Note that whereas the Output 855B spans the full bit range of the k Hamming weight, the projection of the Output 955B is limited to the portion of k corresponding to the specified bit range from m to m′. This processing of FIG. 9A demonstrates that the processing may be started and stopped at bit indexes other than 0 and [log n], thereby giving partial Hamming weight projections according to user specifications.

FIGS. 9B-9D relate to a system such as depicted in FIG. 4 and FIG. 5. In such a system, there is no measurement (observation) for every Hamming weight bit which is produced; instead at least some of the bits may be re-used as a ‘controlled separate operation’. FIG. 4 provides an example of a quantum circuit diagram showing an overview of the components for constructing a single bit controlled Hamming weight projection. If b₁, . . . , bₗ₋₁ are the first l−1 bits of the Hamming weight of q₁, q₂, . . . , qₙ, then the measurement will return the l^{th} bit of the Hamming weight. Without measurement, this quantum circuit is called CP^{l}.

The quantum circuit from FIG. 4 performs the projection in the main “q” register for the space spanned by computational basis states whose Hamming weights agree with the lth bit of k (as long as the input state is in the space spanned by states |b₁ . . . bₗ₋₁ [symbol] 0 [symbol] |q₁ . . . qₙ [symbol] where b₁, . . . , bₗ₋₁ are the first l−1 bits of the Hamming weight Σqᵢ).

FIG. 9B commences with an Input operation 931 which involves preparation of the state |φ> on the main (data) register (analogous to Inbox operation 810 of FIG. 8A). The Input operation 931 further includes cleaning (zeroing) the auxiliary bits on the auxiliary register (again analogous to Inbox operation 810 of FIG. 8A). The Input operation 931 further includes cleaning (zeroing) the control register. The control register may be implemented by any suitable/available element in the quantum computing system. The Input operation 931 further sets m to 0.

In the Assume operation 942, a computational basis state |b [symbol] |0|q [symbol] is assumed in which b₁, . . . , bₗ₋₁, kₗ, . . . kₘ correspond to the first m bits of the Hamming weight Σqᵢ. In the C-Separate box 943 (for controlled separation), a computation is made of the (m+1)^{th} bit of the Hamming weight. Box 944 then performs a test 944 to determine whether m<l−1. Further information about the C-Separate box (operation) is provided below in FIG. 9D.

If the test of box 944 is posiive, we proceed to the Rearrange box 947, whereupon the computed qubit is moved to the control register. The value of m is now incremented, and we return to the Assume box 942 for the next iteration.

On the other hand, if the test 944 is negative, processing flows through to the Measure Box 945, which measures the (m+1)^{th} bit of the Hamming weight as determined at operation 943. If this measured value disagrees with kₘ₊₁, corresponding to option 949, then the computation must be restarted (analogous to the outcome 849 in FIG. 8A). However, if the (m+1)^{th} bit of the Hamming weight agrees with kₘ₊₁, processing is directed to Test 946, which determines if m=u−1. If the deterination is negative, the value of m is now incremented, and we return to the Assume box 942 for the next iteration. Alternatively, if the determination is positive, we progress to the Output box 948, where the state |φ> may be output subject to agreement between the Hamming weight and k between the l^{th} and u^{th} bits.

It can be seen that there are various parallels between the processing of FIG. 9B compared with the processing of FIG. 8A. Thus FIG. 8A has a sequence of Input, Assume, Separate, Measure, and then loop or Output. FIG. 9B also has a sequence of Input, Assume, Separate, Measure and then loop or Output. However, in FIG. 9B the Separate box is for a controlled Separate and there is an additional iteration path involving Test 944 and the Rearrange box 947.

FIG. 9C provides an illustrative example of 3 rounds (iterations) of C-Separate 943 and Rearrange 947 such as shown in FIG. 9B. It can be seen that for each iteration, the projection of the state |φ> becomes increasingly specific but also complex with more terms.

FIG. 9D is a more detailed representation of the C-Separate box 943 from FIG. 9B (in a similar manner to FIG. 8B representing a more detailed view of the Separate box from FIG. 8A). In particular, FIG. 9D depicts the process for performing the projection onto the subspace of states whose Hamming weights agree with k on each of the bits between the lth and uth (inclusive).

As shown in FIG. 9D, the C-Separate box 943 from FIG. 9B comprises an Input 2 box 981 (distinct from the Input box 931 in FIG. 9B), an Entangle operation 982, a Count operation 983, an Adjust operation 984 and a Disentangle operation 985. Accordingly, the sequence of operations in FIG. 9D generally matches the Input 2, Entangle, Count, Adjust and Disentangle operations shown in FIG. 8B.

The Input 2 box 981 in FIG. 9D includes cleaning (zeroing) the qubits on the auxiliary register, as for the Input 2 box 831 in FIG. 8B. However, Input 2 box 981 in FIG. 9D also has entangled data (main) and control registers (which is not the case in FIG. 8B). The Entangle operation 982 in FIG. 9D matches the Entangle operation 832 in FIG. 8B as described above. Likewise, the Count operation 983 in FIG. 9D matches the Count operation 833 in FIG. 8B as described above, with both of these operations 833 and 983 involving the main (data) and auxiliary registers. In particular, Count operation 983 involves, for both data and auxiliary registers, loading the first m+1 of the Hamming weight in the data register into the phase of the GHZ state on the auxiliary register.

The auxiliary and control registers are rotated at Adjust operation 984 so that the possible phases are 0 and π, which is generally the same as the Adjust operation 834 in FIG. 8B. In more detail, for each state in the data register of FIG. 9D, the corresponding phase on the auxiliary register is rotated using controlled rotations from the control register, which ensure the possible phases are 0 and π as mentioned above.

Lastly, the Disentangle operation 985 in FIG. 9D has some overlap with the Disentangle operation 835 in FIG. 8B. In particular, both of these operations are performed on the auxiliary register and utilise a fan-in circuit to reverse the GHZ state preparation and turn phases into measurable binary output. In the particular case of the Disentangle operation 985 of FIG. 9D, the phases are turned into a single bit representing the (m+1)^{th} bit of the values on the data register.

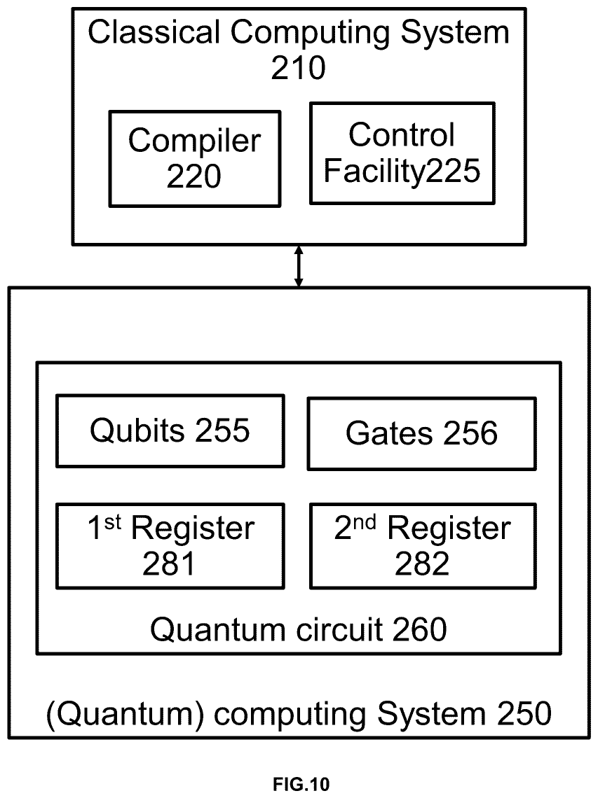

FIG. 10 is a schematic diagram showing a potential implementation of a quantum computing system such as for implementing a method for preparing or maintaining a quantum state having a specified Hamming weight as disclosed herein. The computing system of FIG. 10 comprises two components, a classical computing system 210 and a quantum computer system 250. The classical computing system 210 may comprise a known form of digital computer(s) including one or more processors for executing program instructions and memory for storing the program instructions and data. Note that in some cases, the quantum computer system 250 may be provided by an emulation of a quantum computing system running on (provided by) a classical computer system. Such emulation may be used, for example, when developing a program for use on a quantum computing system, to allow testing of the program in a noise-free environment.

The classical computing system 210 is shown as including two facilities a compiler 220 and a control facility 225. These two facilities are shown for convenience as located on a single classical computing system 210, but they could be provided on two separate classical computing systems if so desired. The compiler 220 is responsible for taking as input program (software) instructions and implementing the instructions on the quantum computer. The control facility 225 provides a facility for a user to control the operation of programs on the quantum computing system 250. For example, the control facility 225 may allow a user to specify settings for the program which are then applied during execution of the program. The control facility 225 may also be used to manage various interoperations between the classical computing system 210 and the quantum computing system 250, for example, transferring a compiled quantum circuit (program) to the quantum computing system 250 for execution.

The quantum computing system 250 includes a quantum circuit 260, which is configured to interact directly with the hardware of the quantum computing system, for example to create and manipulate qubits 255. The quantum computing system 250 further includes various gates 256 for performing operations on the qubits 255. The quantum circuit 260 can be considered as somewhat analogous to a compiled program (low-level code) which has been adapted to run on the specific hardware implementation of the quantum computer, such as reflecting the number and connectivity of the qubits and gates 255 available on the quantum computer.

The quantum computing system 250 of FIG. 10 further includes first (main) and second (auxiliary) registers 281, 282 for storing qubits between performing operations with gates 256. Although the first and second registers 281, 282 are shown separately in FIG. 9, they may be implemented (for example) using a single register having a first portion corresponding to the first register 281 and a second portion corresponding to the second register 282. More generally, it will be appreciated that the configuration and architecture shown in FIG. 9 is provided by way of illustration and not by way of limitation and hence the approach described herein may be implemented on many different types of quantum computing systems or platforms.

The approach described herein for determining Hamming weights introduces a sequential bitwise projection whose components are simpler quantum circuits than those used, for example, in existing implementations in this field. Further, the overall size of the whole sequence is less than for such existing implementations. Compared with such existing implementations, the approach described herein also allows the use of a (much) simpler circuit when a weaker projection is desired (compared with a projection from the full Hilbert space to the desired k-Hamming weight space).

By way of example, we may know that an input state (on 16 qubits say) is a superposition of states of Hamming weight 1, 2, 3, 4, 5 or 6 for example and we want to project onto the part of this state with Hamming weight 4. In general, a state on 16 qubits can have Hamming weight from 0 to 16 and the number 16 has 5 bits in binary. However, in the situation above, and adopting the approach described herein, the possible Hamming weights only go up to 6 (which has 3 bits). The bitwise projection would then only need to run its loop 3 times (rather than 5 times) to achieve the correct projections. In the non-bitwise Hamming weight projections, such a saving is not possible in the same way.

Accordingly, compared to existing implementations for generalised parity measurements, the approach described herein helps to remove the reliance on qubits (which are physically hard to produce and manipulate). In addition, the approach described herein removes reliance on performing a quantum Fourier transform. Such a quantum Fourier transform may be used for performing topological data analysis (TDA) on a noisy intermediate-scale quantum (NISQ) device, but scales unfavourably in terms of size and noise-robustness scales at large values of k. More generally, the approach described herein helps to reduce circuit sizes for certain existing computations, such as computing a k-dimensional Laplacian.

The approach described herein presents (inter alia) two significant developments in determining Hamming weight projections. The first is that the projection is done without preparing a new register containing the entire Hamming weight, which is typically performed using existing techniques, see (i) the generalised parity measurements of lonicioiu et al. and (ii) the direct computation of Akhalwaya et al. (both as cited above).

This difference is significant because these previous methods require an auxiliary register which grows with the number of qubits in the main register, whereas the approach described herein may use only 1 or 2 qubits in the auxiliary register. The present approach also has the flexibility to use additional auxiliary qubits (or indeed qudits) if such resources are available. As presented herein, every additional auxiliary qubit shortens the circuits by a constant factor.

The second development is the adaptable use of different rounds in the bitwise construction. In previous work such as mentioned above, the projections onto Hamming weight states are done in a single shot, usually consisting of a measurement with n outcomes. In contrast, the approach disclosed herein uses a sequence of logn measurements each having 2 outcomes. This distinction has (at least) two important advantages over the one-shot approach based on a single measurement with n outcomes.

Firstly, the sequence of measurements allows us to detect most projection failures without running the entire circuit. For problems such as probabilistic quantum state preparation, this means that we can detect and restart failed preparations much earlier, thereby leading to an overall quicker preparation of states.

Secondly, in the present approach, certain rounds of measurement may be omitted. In effect, this allows a measurement to be made which is targeted at only certain bits of the Hamming weight. This adaptability helps to save resources in situations where the full Hamming weight projection is not required. For example, in a situation in which the states on a quantum computer are used to represent superpositions over arrangements of a fixed number of particles, a quantum circuit may be applied which simulates some rounds of adding and removing particles in this system. If we then want to project to those states which have a particular number of states remaining it will frequently be the case that we know the states after this process will have a number of particles in some small range. By applying a few rounds of the bitwise projection, the Hamming weights of the output states can be distinguished without using the full Hamming weight projection.

Other advantages of the approach described herein are that the bitwise Hamming weight projection retains the flexibility that full computation has of making a projection onto a union of Hamming weight subspaces. In addition, quantum circuits such as those used for the Laplacian contain guarantees that the mid-circuit states don't stray too far from the desired subspace and so involve only the simpler projections which can be achieved by the bitwise formulation.

### 5. Projections Between Direct Sums of Hamming Weight Subspaces

In general, we adapt the procedure depicted in FIG. 7 to perform a Hamming weight projection procedure on n qubits can be defined for any set l={x₁, . . . , xₘ} of Hamming weights (between 0 and n) and any subset 0={xᵢ_{₁}, . . . , xᵢ_{ₗ}}. This projection which we will call t_{l,O} is realised as a method for processing a quantum state on n qubits which is restricted to the subspace of the full n-qubit Hilbert space defined by W₁=⊕_{i∈l} [symbol] and producing the state representing the projection of the input to the space W₀=⊕_{j∈o} [symbol] ⱼ. This will not work for all choices of I and O as explained below in step 3a. The method for performing this projection is as follows:
1. On a classical computing system, produce a set B, whose elements correspond to bit indices b for which each element of O agrees on the value at bit index b.
2. For each element b∈B, store on the classical computing system the subset of values I_{b} of the set I for which the value of the bit at index b disagrees with the value of the bit at index b for all elements of O.
3. Using a classical computing system to control a quantum computer with three registers as depicted in FIG. 7 (call these control, auxiliary and data), iterate through the bit indices 0 to [logn] starting at the least significant bit and for each new index b:
   a. If b is in B and I_{b} is empty proceed to the index. If I_{b} is not empty perform a controlled projection for that bit onto any Hamming weight from the set O. If the projection is successful, remove the elements of I_{b} from I and all subsequent sets I_{b′}, b′∈B.
      If I=O after this update, exit and proceed to Step 4.
      If b=┌logn┐ and I is not equal to O then the desired projection is not possible.
   b. If b is not in B, then compute the bit onto the control register using the procedure shown in FIG. 5 (without the measurement). The control bits are all previous bits computed using Step 3 b and the single qubit adjustment is Σbⱼ2^{j}/2^{b} where the sum is taken over all bⱼ which have been processed in Step 3 a up to this point of the computation.
4. Return the control register to its original state (uncompute) by reversing all the single bit computations from Step 3 b.

This method enables more general projections than those described in FIG. 7. In particular, taking I=[0, 1, . . . , 25] and O=[10, 11, 14, 15], the above process would allow us to perform this separation with 4 loops of Step 3, computing bits 0 and 2 to the control register, measuring bits 1 and 3 and ignoring bit 4. The advantages on resource savings can be seen mostly in Step 3 a. The ability to skip certain projections (if they do not reduce the size of I) and to finish early (if I has already been reduced to the target set O) will save on projections and reverse computations. In the given example we perform the projection with 2 single-bit computations, 2 single-bit projections and 2 single-bit reverse computations. The equivalent projection performed as two applications of the projection in FIG. 7 would require 4 single-bit computations, 2 single-bit projections and 4 single-bit reverse computations.

### 6. Detecting Errors in on NISQ Quantum Devices

A recognised limitation of NISQ quantum computing devices is the rate at which errors occur when performing entangling (2-qubit) operations on the qubits. We refer to this in this section as two-qubit gate error and it is given as a proportion of two-qubit operations which are expected to produce an error. On some ion-trap devices, two-qubit gate error was in the range 10⁻³ to 10⁻⁴. These errors (when undetected) reduce the quality of the output (the signal produced) from any computation on the quantum device. It is thus advantageous to detect errors where possible and to use this capability to counteract the effect of error on the output by repeating and/or restarting operations or reweighting output data. Our procedure configured such that there is an advantageous opportunity to detect errors in certain computations.

As mentioned above (in page 19, line 9), there are situations where rounds of the of the Hamming weight projection can be removed when we know that the quantum state being processed is contained in a restricted Hamming weight subspace of the full Hilbert space on n-qubits. Instead of omitting these rounds to save resources, we have the option to include them and use their output for error detection in noisy devices. This would work as follows, for any Hamming weight projection from one restricted Hamming weight space to another if a simple “bit flip error” (a |0> state becomes a |1> state on some qubit in the device) has occurred at some point in the computation, this error can be detected by the Hamming weight shifting by one (similarly compounding bit flip errors can result in larger shifts).

Where such a shift would be detected by measuring an additional bit of the Hamming weight, we can include the corresponding round and use its output solely for error detection. As these rounds are not necessary for the computation but only for error detection, they can be included or excluded by a classical control system according to their running cost and the expected noise of the quantum device. For example, given a characterisation of the expected gate error of the device, it is possible to compute the probability that performing one such error-detection round of the Hamming weight projection introduces a new error (call this p_{new err}) depending on the computation performed up to this point it may also be possible to compute the probability that an error has occurred which is detectable by this round of Hamming weight projection (call this p_{old err}).

Then the classical control could be programmed with a logic that decides when to perform the additional error detection rounds. A simple example of this logic may be to perform such a round when it is more likely that such a round detects an error than introduces one (p_{new err}<(1−p_{new err})×p_{old err}). In procedures where a single round of Hamming weight projection uses a small percentage of the total number of two qubit gates (e.g. in TDA application) this condition is frequently satisfied. This logic can also be made probabilistic rather than deterministic which will mitigate the risk of such error detection introducing bias in the data (e.g. by focusing only on detecting a single type of error).

In conclusion, various implementations and examples have been disclosed herein. It will be appreciated that these implementations and examples are not intended to be exhaustive, and the skilled person will be aware of many potential variations and modifications of these implementations and examples that fall within the scope of the present disclosure. It will also be understood that features of particular implementations and examples can typically be incorporated into other implementations and examples (unless the context clearly indicates to the contrary). In summary, the various implementations and examples herein are disclosed by way of illustration rather than limitation, and the scope of the present invention is defined in the appended claims.

1. A method for using a quantum computer system comprising a first register and a second register to separate a quantum state into multiple subspaces of a 2ⁿ dimensional Hilbert space, the method comprising:
defining a quantum state comprising 2ⁿ elements on the first register, the first register comprising n qubits;
defining a quantum state on the second register, the second register comprising one or more qubits;
receiving a value k, where k is a binary integer such that 0=<k=<n; and
performing a bit-wise iteration process comprising: (i) performing a quantum entanglement between the first and second registers to separate the quantum state on the first register into distinct subspaces of the Hilbert space which are indexed by the entangled values on the second register, and (ii) measuring an outcome on the second register to find a match with a portion of k, wherein said portion of k increases incrementally with the iteration process until the match is with all of k,
whereby the bit-wise iteration is used to separate the quantum state on the first register into distinct subspaces of the Hilbert space, wherein elements of the distinct subspaces have different Hamming weights and exactly one of the subspaces contains only elements of Hamming weight k.

2. The method of claim 1, further comprising using the quantum computer system to perform projections from the 2ⁿ dimensional Hilbert Space on n qubits, Hₙ, to the space spanned by computational basis states having Hamming weight k, Wₖ.

3. The method of claim 2, further comprising utilising a modular measurement-based procedure to perform the projections by breaking up the full projection Pₖ: [symbol] ₙ→ [symbol] ₖ into a series of smaller projections.

4. The method of claim 3, wherein the full projection Pₖ: [symbol] ₙ→ [symbol] ₖ is determined by generating (i) an initial projection Pₖ¹ which projects from Hₙ to the space spanned by computational basis states whose Hamming weight has the same first bit as k, (ii) a sequence of relative projections Pₖ^{m-1,m} for the mth bit of k for m=2 to n, which projects from Hₙ to the space spanned by computational basis states whose Hamming weight has the same mth bit as k, given that the Hamming weights agree with k for the first m−1 bits.

5. The method of claim 4, further comprising assembling the initial projection Pₖ¹ and the sequence of relative projections to form the full projection, Pₖ.

6. The method of claim 4, further comprising, for the initial projection, the steps of:
a Step 1 of preparing on the second register a Greenberger-Horne-Zeilinger (GHZ) state, namely |├GHZ_α [symbol] ┤=1/√2(|├0 . . . 0 [symbol] ┤+|├1 . . . 1 [symbol] ┤);
a Step 2 of applying, for each qubit in the first register, a controlled z-rotation gate providing a fixed angle θ to the second register controlled by that qubit;
a Step 3 of applying a z-rotation of −kθ to any of the qubits of the second register;
a Step 4 of applying the inverse of the GHZ state preparation circuit to the second register; and
a Step 5 of measuring the first qubit in the computational basis, wherein the projection succeeds if the outcome of the measurement is |0 [symbol] .

7. The method of claim 6, further comprising at least one of:
applying at Step 1 a Hadamard followed by a “fan-out” circuit which may be performed in log depth;
applying at Step 2 a rotation of
$$θ = \frac{π}{2}$$
to any qubit ot the second register; and/or
cycling at Step 2 through the auxiliary qubits in turn as the controlled rotations are applied to minimise gate depth.

8. The method of claim 4, wherein the output of a successful relative projection performed on an input state is in the space spanned by all computational basis states whose Hamming weights agree with k on the m+1th bit, wherein the input state must be in the space spanned by all computational basis states whose Hamming weights agree with k on every bit up to the mth bit.

9. The method of claim 6, wherein generating the relative projections Pₖ^{m-1,m} includes applying the same process as for the initial projection but with
$$θ = \frac{π}{{2}^{m}}$$
for Step 2.

10. The method of claim 9, further comprising the use of a parallel version for
$$θ = \frac{π}{{2}^{m}}$$
in which all rotations are performed in depth [n/f] with any whole number t of bits in the second register, where (1≤t≤n).

11. The method of claim 10, wherein the parallel version is implemented for
$$θ = \frac{π}{{2}^{m}}$$
with all rotations being performed in depth 2 using n/2 auxiliary qubits.

12. The method of claim 3, wherein the full projection is implemented as a product of successive projections by successively applying the single bit projections:
$$\begin{matrix}{P}_{k} = {P}_{k}^{m - 1 , m} for m = 1 , … , ⌈ log n ⌉ \\ = {P}_{k}^{m - 1 , m} … {P}_{k}^{1 , 2} \cdot {P}_{k}^{0 , 1} where m = ⌈ log n ⌉\end{matrix}$$
wherein the full projection Pₖ succeeds if and only if each of the constituent projections succeeds.

13. The method of claim 12, wherein the method is configured to detect failure of the projection at multiple points in the running of the quantum circuit leading to a shorter circuit on average.

14. The method of claim 13, further comprising responding to a detected failure of the projection by resetting the quantum computing system to restart the method from the beginning.

15. The method of claim 1, wherein intermediate information generated while performing the bit-wise iteration process is stored in the phase of the second register and not in the bits of the second register.

16. The method of claim 1, wherein the method is configured to project onto the space spanned by states whose Hamming weight agrees with k on the lth bit alone without any assumption on the other bits.

17. The method of claim 1, wherein the method is adopted to:
(i) prepare a desired quantum state for use in a later quantum computation, whereby repetition is performed until the desired quantum state has been successfully achieved; and/or
(ii) determine what fraction of an input state satisfies conditions for projections to succeed by repeated running of a circuit for the projections and counting the successes and failures until enough samples have been achieved to allow the fraction to be determined.

18. The method of claim 1, wherein a single bit projection quantum circuit is controlled to perform further projections based on the Hamming weight of an n-qubit state, such as by using single bit projection modules without measurement to prepare additional auxiliary qubits which store some bits of the Hamming weight.

19. The method of claim 1, wherein the second register comprises 1 or 2 qubits.

20. The method of claim 1, further comprising omitting one or more rounds of measurement during the iterative process, thereby allowing a measurement to be made which is targeted at only certain bits of the Hamming weight.

21. The method of claim 1, the method including:
defining a quantum state comprising 2ⁿ elements on the first register of the quantum circuit, the first register comprising n qubits;
defining a quantum state on the second register of the quantum circuit, the second register comprising one or more qubits;
receiving a value k, where k is a binary integer such that 0=<k=<n;
performing a bit-wise iteration, starting at i=1 corresponding to a least significant bit of k, wherein each iteration comprises:
(a) performing a quantum entanglement between the quantum state of the first register and the quantum state of the second register, wherein performing the quantum entanglement includes making a projection of the n qubit state to a subspace U which contains the k Hamming weight subspace;
(b) deriving a bit from the quantum entanglement by making a measurement of the second register to realise the projection;
(c) determining whether or not the derived bit is equal to the ith bit of k;
(d) if the derived bit is not equal to the ith bit of k, terminating the method as failing; and
(e) if the derived bit is equal to the ith bit of k, incrementing iby one and performing the next iteration, wherein the subspace U converges to the k Hamming weight over the course of the iterations;
and terminating the bit-wise iteration as a success if the derived bit for i=[log(n+1)] is equal to the most significant bit of k, indicative of the system determining a quantum state having a Hamming weight of k.

22. A method of using a quantum computer system having a first register providing n qubits and a second register, the method performing a projection from a 2ⁿ dimensional Hilbert Space on n qubits by:
a step of preparing on the second register a Greenberger-Horne-Zeilinger (GHZ) state, namely |├GHZ_α [symbol] ┤=1/√2(|├0 . . . 0 [symbol] ┤+|├1 . . . 1 [symbol] ┤);
a step of applying, for each qubit in the first register, a controlled z-rotation gate to the second register controlled by that qubit;
a step of applying a rotation of θ=−kθ to any of the qubits of the second register;
a step of applying the inverse of the GHZ state preparation circuit to the second register; and
a step of measuring the first qubit in the computational basis, wherein the projection succeeds if the outcome of the measurement is |0 [symbol] .

23. The method of claim 1 wherein:
the measuring of an outcome on the second register is used to detect an error; and
if an error is detected, terminating the method as failing and restarting the method from the beginning.

24. The method of claim 23, wherein the measurement comprises measuring an additional bit of the Hamming weight to detect a bit flip error.

25. The method of claim 23 further comprising using a classical computer system to determine whether to perform an error-detection scheme based on a running cost of the iterative process and/or an expected noise of the quantum computer system.

26. A quantum computing system configured to perform the method of claim 1.

27. A method for using a quantum computer system comprising a first register and a second register to separate a quantum state into multiple subspaces of a 2ⁿ dimensional Hilbert space, the method comprising:
defining a quantum state comprising 2ⁿ elements on the first register, the first register comprising n qubits;
defining a quantum state on the second register, the second register comprising one or more qubits;
receiving a set O of values k, where each kis a binary integer such that 0=<k=<n;
producing a set B, whose elements correspond to bit indices b; for which each element of O agrees on the value at bit index bⱼ; and
performing a bit-wise iteration process comprising: (i) performing a quantum entanglement between the first and second registers to separate the quantum state on the first register into distinct subspaces of the Hilbert space which are indexed by the entangled values on the second register, and (ii) measuring an outcome on the second register to find a match with a portion of the bit indices in set B, wherein said portion of bit indices in set B increases incrementally with the iteration process until the match is with all bit indices in set B,
whereby the bit-wise iteration is used to separate the quantum state on the first register into distinct subspaces of the Hilbert space, wherein elements of the distinct subspaces have different Hamming weights and exactly one of the subspaces contains only elements whose values agree with all bit indices in set B.
